(19) United States
(12) Patent Application Publication
(10) Pub. No.: US 2025/0202091 A1
(43) Pub. Date: Jun. 19, 2025

(54) Waveguide Device

(71) Applicant: TAIYO YUDEN CO., LTD., Tokyo (JP)

(72) Inventor: Hiroyuki KAMO, Tokyo (JP)

(73) Assignee: TAIYO YUDEN CO., LTD., Tokyo (JP)

(21) Appl. No.: 19/072,709

(22) Filed: Mar. 6, 2025

Related U.S. Application Data
(63) Continuation of application No. PCT/JP2023/032219, filed on Sep. 4, 2023.

(30) Foreign Application Priority Data
Sep. 30, 2022 (JP) 2022-158910

(51) Int. Cl. H01P 3/123

(52) U.S. Cl. CPC H01P 3/123

(57) ABSTRACT

A waveguide device 100 comprises: a first member 10 that has a conductive surface 11 and a through-hole 14 penetrating a space between the surface 11 and a surface 15 on the reverse side and having a conductive inner surface; a second member 20 that has a conductive surface 21 facing the surface 11; a waveguide member 40a that is provided to extend in a planar direction between the surfaces 11, 21, is in contact with the surface 11, forms a gap 42 with the surface 21, and has a tip 45 adjacent to the through-hole 14 and a conductive waveguide surface 41 facing the surface 21; a plurality of rods 30 each having a conductive surface that are provided around the waveguide member 40a between the surfaces 11, 21, are in contact with the surface 11, form a gap 31 with the surface 21, and are not disposed between the through-hole 14 and the tip 45 of the waveguide member 40a; and a wall portion 50a that is in contact with or is high-frequency coupled to the surfaces 11, 21 and provided adjacent to the through-hole 14 without the rods 30 interposed therebetween between the surfaces 11, 21, and has conductive side surfaces.

### CROSS-REFERENCE TO RELATED APPLICATIONS

This application is a bypass continuation of International Application No. PCT/JP2023/032219, filed Sep. 4, 2023, which claims the benefit of Japanese Application No. 2022-158910, filed Sep. 30, 2022, in the Japanese Patent Office. All disclosures of the documents named above are incorporated herein by reference.

### BACKGROUND OF THE INVENTION

### 1. Field of the Invention

Aspects of the present invention relate to a waveguide device.

### 2. Description of the Related Art

Waveguide devices are known to propagate high-frequency electromagnetic waves, including those in the millimeter wave band, with low leakage loss by using rows of conductive rods (see, for example, U.S. Pat. No. 8,803,638 B2, EP 1331688 A1, WO 2017/078183 A1, and WO 2018/190343 A1). These waveguide devices typically include two plate-shaped members with conductive surfaces. Rows of conductive rods can be arranged on the surface of, for example, the first member to suppress leakage of the propagating electromagnetic waves. In addition, waveguide members (ridges) that extend along the surface of the first member are provided between the rows of conductive rods. The second member covers the rows of conductive rods on the surface of the first member and the waveguide members opposing them. Electromagnetic waves propagate along the waveguide members. Also known in the art is a configuration in which a peripheral wall portion is provided around the first and second members, outside the waveguide region (for example, outside the rows of conductive rods), to position and secure the first and second members (see, for example, U.S. Pat. No. 8,803,638 B2).

### SUMMARY OF THE INVENTION

In U.S. Pat. No. 8,803,638 B2, the first and second members in the direction of the first and second members facing each other to constitute the waveguide device are positioned by the peripheral wall portion surrounding the first and second members outside the waveguide region. Therefore, if the first and/or second members are, for example, warped, the spacing between the first and second members may widen or narrow in the central portion or elsewhere. Because electromagnetic waves propagate through the gaps above the waveguide members, the height of the gaps above the waveguide members should be precise. However, because the gap between the first and second members may change in the central portion or elsewhere in U.S. Pat. No. 8,803,638 B2, the height of the gaps above the waveguide members may differ from the desired size.

In view of this problem, it is an object of the present invention to provide a waveguide device that enables the height of the gaps above the waveguide members to be set to a desired size.

According to an aspect of the present invention, aa waveguide device comprises: a first member that has a conductive first surface and a first through-hole passing between the first surface and a second surface on the side opposite the first surface and having a conductive inner surface in contact with the first surface; a second member that has a conductive third surface facing the first surface; a waveguide member that is provided to extend in the planar direction of the first surface between the first surface and the third surface, is in contact with first surface, forms a first gap with the third surface, and has a tip adjacent to the first through-hole and a conductive waveguide surface facing the third surface; a plurality of rods each having a conductive surface that are provided around the waveguide member between the first surface and the third surface, are in contact with one of the first surface and the third surface and form a second gap with the other surface, and are not arranged between the first through-hole and the tip of the waveguide member; and a wall portion that is in contact with or is high-frequency coupled to the first surface and the third surface and provided adjacent to the first through-hole between the first surface and the third surface without the rods interposed therebetween, and has at least a conductive side surface on the first through-hole side.

In the configuration described above, the side surface of the wall portion can be located opposite to tip of the waveguide member with the first through-hole interposed therebetween.

In the configuration described above, the side surface of the wall portion can be perpendicular to the direction in which the waveguide member extends to the tip.

In the configuration described above, the wall portion can have a step portion away from the second member at a point on the surface of the second member side that is located on the first through-hole side.

In the configuration described above, the length of the side surface of the wall portion in the planar direction can be greater than the length of the first through-hole in the direction in which the side surface of the wall portion extends in plan view.

In the configuration described above, some of the plurality of rods can surround the wall portion except between the wall portion and the first through-hole.

In the configuration described above, the length of the side surface of the wall portion in the planar direction can be greater than the distance between the first surface and the third surface at the location of the wall portion.

In the configuration described above, the plurality of rods can extend toward the third surface in contact with the first surface and form a second gap between them and the third surface.

The configuration described above can further comprise a fastening member that fastens the second member to the wall portion.

In the configuration described above, the top surface of the wall portion can have a second through-hole or recessed portion, and the second member can be fastened to the wall portion by inserting the fastening member into the second through-hole or recessed portion.

In the configuration described above, the wall portion can have a groove in a direction intercepting the direction in which the tip of the waveguide member and the side surface of the wall portion face each other, located between the second through-hole or recessed portion and the first through-hole on the top surface, and the depth of the groove can be within the range of λ₀/4±λ₀/8 where λ₀ is the free-space wavelength at the center frequency of the frequency band being used.

In the configuration described above, the groove can be provided around the second through-hole or recessed portion.

In the configuration described above, the wall portion can define the distance between the first member and the second member.

The configuration described above can further comprise a dielectric film between at least one of the first surface and the second surface and the wall portion.

An aspect of the present invention is able to set the height of the gap above the waveguide member to the desired size.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a plan view of the waveguide device in Example 1, and FIG. 1B and FIG. 1C are cross-sectional views.

FIG. 2 is a perspective view of the second member and the fastening member in the waveguide device of Example 1.

FIG. 3A is a plan view of the wall portion in Example 1, FIG. 3B is a cross-sectional view of FIG. 3A from A-A, FIG. 3C is a cross-sectional view of FIG. 3A from B-B, and FIG. 3D is a cross-sectional view of FIG. 3A from C-C.

FIG. 4A and FIG. 4B are cross-sectional views of the waveguide device in the comparative example, and FIG. 4C is a perspective view of the second member in the waveguide device in the comparative example.

FIG. 5A is a cross-sectional view of Sample 1 used in Simulation 1, and FIG. 5B is a perspective view of the second member in Sample 1.

FIG. 6A is a cross-sectional view of Sample 2 used in Simulation 1, and FIG. 6B is a perspective view of the second member in Sample 2.

FIG. 7A shows the results for Sample 1 in Simulation 1 and FIG. 7B shows the results for Sample 2 in Simulation 1.

FIG. 8A is a cross-sectional view of the waveguide device used in Simulation 2, and FIG. 8B shows the results of Simulation 2.

FIG. 9A is a cross-sectional view of the waveguide device used in Simulation 3, and FIG. 9B shows the results of Simulation 3.

FIG. 10A to FIG. 10D are cross-sectional views of other examples of wall portions in Example 1 (1 of 2).

FIG. 11A to FIG. 11D are cross-sectional views of other examples of wall portions in Example 1 (2 of 2).

FIG. 12 is a cross-sectional view used to explain the electrical effect of providing a wall portion adjacent to the through-hole in Example 1.

FIG. 13A and FIG. 13B are cross-sectional views of a wall portion provided with a recessed portion.

FIG. 14A and FIG. 14B are cross-sectional views of the waveguide devices in Modified Examples 1 and 2 of Example 1, and FIG. 14C is a perspective view of the rods in Modified Example 3 of Example 1.

FIG. 15A and FIG. 15B are cross-sectional views showing the vicinity of the wall portion in Modified Examples 4 and 5 of Example 1.

FIG. 16A and FIG. 16B are plan views showing the vicinity of the wall portion in Modified Examples 6 and 7 of Example 1, and FIG. 16C is a cross-sectional view of the wall portion in FIG. 16A and FIG. 16B from A-A.

FIG. 17 is a perspective view of the second member and the fastening member in the waveguide device in Example 2.

FIG. 18 is a cross-sectional view of another example of rods.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The following is a description of examples of the present invention with reference to the drawings.

### Example 1

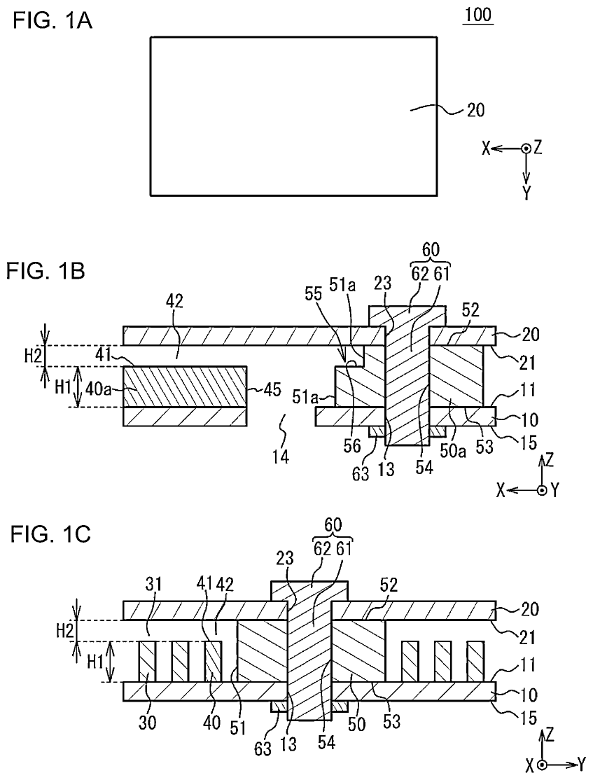

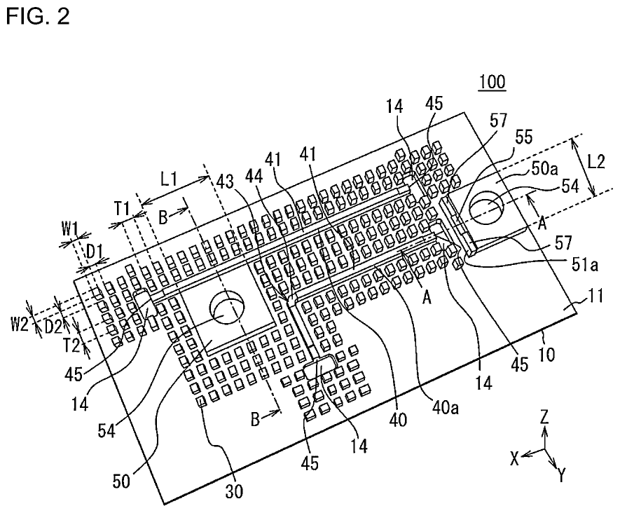

FIG. 1A is a plan view of the waveguide device 100 in Example 1, and FIG. 1B and FIG. 1C are cross-sectional views of the waveguide device 100 in Example 1. FIG. 2 is a perspective view of the second member 20 and the fastening member 60 in the waveguide device 100 of Example 1. FIG. 1B is a cross section of the portion corresponding to A-A in FIG. 2, and FIG. 1C is a cross section of the portion corresponding to B-B in FIG. 2. FIG. 1A, FIG. 1B, FIG. 1C, and FIG. 2 show XYZ coordinates indicating the mutually orthogonal X, Y, and Z directions. The Z direction is perpendicular to the surface 11 of the first member 10 facing the second member 20. The X direction is parallel to one direction in which the plurality of rods 30 are arranged, and the Y direction is parallel to the other direction.

As shown in FIG. 1A, FIG. 1B, FIG. 1C, and FIG. 2, the waveguide device 100 in Example 1 has a plate-shaped first member 10 and second member 20, each of which is spread along the XY plane, facing each other in the Z direction and arranged approximately parallel to each other. The first member 10 has a conductive surface 11 (“conductive surface 11” below) facing the second member 20. The second member 20 has a conductive surface 21 (“conductive surface 21” below) facing the first member 10. The first member 10 and second member 20 may be conductive members such as metal members, or conductive films such as metal films may be provided on the surface of insulating members such as resin members. The waveguide device 100 further comprises a waveguide member 40, 40a having, for example, a ridge disposed on the conductive surface 11 of the first member 10, and a plurality of rods 30 arranged on both sides of the waveguide member 40, 40a. Below, an electromagnetic waveguide utilizing a conductive member with an array of rods 30 may sometimes be referred to as a WRG (Waffle iron Ridge Waveguide).

The waveguide member 40, 40a is formed integrally with the first member 10, for example, as part of the first member 10, and extends in the planar direction of the conductive surface 11 of the first member 10. In the present specification, “integral” includes situations in which two members with conductive surfaces are continuously formed of the same material, for example, by integral die-casting of metal. It also includes situations in which two members with conductive surfaces have a structure that maintains contact and are secured using screws or a similar means. As in the case of the first member 10, the waveguide member 40 may be a conductive member such as a metal member, or a conductive film such as a metal film may be provided on the surface of an insulating member such as a resin member. The waveguide member 40 extends rectilinearly in the X direction. The waveguide member 40a has an L-shaped bent portion 43 extending from the Y direction to the X direction, and aligned in the Y direction with the waveguide member 40. The waveguide members 40, 40a are not in contact with the second member 20, but are provided away from the conductive surface 21 of the second member 20. In the present specification, two members having conductive surfaces making “contact” means they are physically in contact and electrically conductive with each other. The surface of the waveguide member 40, 40a facing the conductive surface 21 (the end surface on the +Z direction side) is a conductive waveguide surface 41. The waveguide surface 41 extends along the direction in which the waveguide members 40, 40a extend. A gap 42 is formed between the conductive surface 21 and the waveguide surface 41. In this gap 42, a waveguide for electromagnetic waves is formed. In other words, electromagnetic waves propagate through the gap 42.

The waveguide formed above the waveguide surface 41 of the waveguide member 40a experiences a change in impedance in the bent portion 43 of the waveguide member 40a. In the waveguide member 40a, a recessed portion 44 is provided on the top surface of bent portion 43 to match the impedance in the bent portion 43 with that of the straight portion.

The plurality of rods 30 are formed integrally with the first member 10, for example as part of the first member 10, and extend from the conductive surface 11 toward the second member 20. The rods 30 have a conductive surface. As in the case of the first member 10, a rod 30 may be a conductive member such as a metal member, or a conductive film such as a metal film may be provided on the surface of an insulating member such as resin member. A gap 31 is formed between the tip of the rods 30 and the conductive surface 21 of the second member 20, and the tip of the rods 30 does not make contact with the conductive surface 21. The placement of the plurality of rods 30 around the waveguide members 40, 40a act as a magnetic wall and suppresses leakage of electromagnetic waves propagating through the gap 42 on the waveguide members 40, 40a to the sides. The tips of some of the plurality of rods 30 may make contact with the conductive surface 21 if a gap 31 is formed between the conductive surface 21 and tips of the rods 30 positioned within the range of a plurality of rods 30 that are effective in suppressing electromagnetic wave leakage.

The plurality of rods 30 may be, for example, cuboid in terms of shape. The placement periods T1 and T2 of the plurality of rods 30 are smaller than λ₀/2, for example, about λ₀/4 and within the range of λ₀/4±λ₀/8, where λ₀ is the free-space wavelength of the electromagnetic waves propagating in the waveguide device 100. Placement period T1 and placement period T2 may be the same or different. The widths W1 and W2 of the rods 30 and the spacings D1 and D2 between rods 30 may be, for example, about λ₀/8 or smaller than λ₀/4 and larger than λ₀/16. Width W1 and width W2 can be the same or different. Spacing D1 and spacing D2 can also be the same or different. The rods 30 and the waveguide members 40, 40a have approximately the same height H1, and the height H1 is, for example, larger than width W1 and W2 of the rods 30, such as approximately λ₀/4 or within the range of λ₀/4±λ₀/8. The height H2 of the gap 31 between the tip of the rods 30 and the conductive surface 21 is approximately the same as the height H2 of the gap 42 between the waveguide surface 41 and the conductive surface 21, which is, for example, approximately λ₀/8 or smaller than λ₀/4. Free-space wavelength λ₀ is used here as it is difficult to grasp the wavelength of electromagnetic waves propagating within a waveguide device 100 because it depends on the dimensions and shape of the various components in the device. The frequency band used in the waveguide device 100 can be, for example, 30 GHz to 300 GHz.

The first member 10 has a through-hole 14 adjacent to the tip 45 of the waveguide members 40, 40a and passing between the conductive surface 11 of the first member 10 and the surface 15 opposite the conductive surface 11. The term “adjacent” refers to the state of being placed in close proximity without any other conductive object interposed between. The through-hole 14 has a conductive inner surface. The through-hole 14 serves to connect the waveguide formed in the layer below the first member 10 to the waveguide formed in the gap 42 above the waveguide members 40, 40a. For example, electromagnetic waves propagating through the gap 42 above the waveguides 40, 40a are inputted from the through-hole 14 adjacent to the tip 45 of one of the waveguides 40, 40a respectively, and outputted through the through-hole 14 adjacent to the tip 45 of the other waveguide. The placement of the rods 30 on the side with the through-hole 14 provides a structure that has an electromagnetic wave propagation blocking effect.

The waveguide device 100 also has a wall portion 50, 50a that extends from the conductive surface 11 of the first member 10 to the conductive surface 21 of the second member 20. For example, the wall portion 50, 50a may be formed integrally with the first member 10, as a part of the first member 10, and protrude from the conductive surface 11, contacting the conductive surface 21 of the second member 20 at the top end (+Z direction end). The wall portion 50, 50a may be made of a conductive material such as a metal member, or a conductive film such as a metal film may be formed on the surface of an insulating member such as resin member.

The wall portion 50 is arranged adjacent to waveguide member 40. In other words, there are no other members such as rods 30 in the adjacent region between the wall portion 50 and the waveguide member 40, and the wall portion 50 faces the waveguide member 40 without having to go through any other members. The term “adjacent” here refers to the state of being placed in close proximity via a gap or dielectric film without another conductive object in between. In such cases, the distance between two adjacent members with conductive surfaces can be, for example, about λ₀/4. The side surface 51 of the wall portion 50 facing the waveguide member 40 has a spread in the direction in which the waveguide member 40 extends. At least this side surface 51 of the wall portion 50 is conductive, for example, electrically conductive with the conductive surface 11 of the first member 10 and the conductive surface 21 of the second member 20. Here, “electrically conductive” means not only that part of the wall portion 50 is in physical contact with these conductive surfaces 11, 21, but also that it is separated by a non-conductive micro gap. It also includes cases in which it is not DC-conductive, but high-frequency coupled and mutually conductive in the frequency band used. In the present specification, this is referred to as the “high-frequency coupling” state. This micro gap has a gap dimension of, for example, 100 μm or less (for example, λ₀/40 or less when the center frequency of the frequency band used (operating frequency band) is 79 GHz), and this gap may be an air layer or a dielectric layer such as a non-conductive resin. The dimensions of the micro gap where this high-frequency coupling condition occurs depend at least on the area of the two conductive surfaces facing each other in this micro gap. Therefore, for example, when two members with conductive surfaces are arranged with a micro gap of 100 μm or more, whether or not they are in a high-frequency coupled state depends also on the structure at the time. This can be determined from the results of electromagnetic simulation during the design stage.

The side surface 51 of the wall portion 50 extends along the waveguide member 40. Here, “along the waveguide member 40” includes situations in which the side surface 51 is perfectly parallel to the waveguide member 40 as well as situations in which the side surface 51 is inclined with respect to the waveguide member 40. The length L1 of the side surface 51 in the direction along the waveguide member 40 (X direction) can be of various sizes, but it is preferably, for example, larger than the spacing between the conductive surface 11 and conductive surface 21 at the location of the wall portion 50. When the length L1 is less than half the wavelength of the electromagnetic waves propagating through the waveguide device 100, the difference with respect to the width W1 of the rods 30 in the direction along the waveguide member 40 becomes small, and the effect of suppressing leakage of electromagnetic waves propagating through the gap 42 above the waveguide member 40 to the sides is disrupted. Therefore, the length L1 of the side surface 51 of the wall portion 50 is preferably at least λ₀/2, more preferably at least 3λ₀/4, and even more preferably at least λ0. The width of the wall portion 50 in the Y direction is, for example, λ₀/2 or more, but may be λ₀ or more. As mentioned above, because the placement periods T1, T2 of the plurality of rods 30 are about λ₀/4, the length L1 is preferably at least two times, more preferably at least three times, and even more preferably at least four times the placement periods T1, T2. In the example in FIG. 2, the length L1 is 5.5 times the placement period T1 of the plurality of rods 30. Note that it is possible to use a length L1 that is less than λ₀/2.

The top end of the side surface 51 of the wall portion 50 is preferably in contact or inductively coupled with the conductive surface 21 of the second member 20 and electrically conductive with the conductive surface 21. At least a portion of the top end (including the top surface) of the wall portion 50 is preferably in contact or inductively coupled and electrically conductive with the conductive surface 21 of the second member 20. The top end of the wall portion 50 and the conductive surface 21 may be configured with a conductive material, such as a conductive adhesive, conductive oil, conductive rubber, or elastic conductive resin between the top end of the wall portion 50 and the conductive surface 21. The top end of the wall portion 50 and the conductive surface 21 may have a micro gap or be electrically separated by a thin non-conductive film. In this case, if the electromagnetic waves are in a high-frequency coupled state in the frequency band used, the effect of suppressing electromagnetic wave leakage due to the wall portion 50 can be realized. In other words, as long as the effect of suppressing the leakage of electromagnetic waves occurs due to the wall portion 50, it is thought that the wall portion 50 and the second member 20 are in a high-frequency coupled state.

The wall portion 50a is located adjacent to the through-hole 14. For example, the wall portion 50a is positioned adjacent to the through-hole 14 on the opposite side of the tip 45 of the waveguide member 40a with respect to the through-hole 14. In other words, no other members such as rods 30 are disposed in the adjacent region between the wall portion 50a and through-hole 14, and the wall portion 50a is adjacent to through-hole 14 without any other members interposed therebetween. A side surface 51a of the wall portion 50a portion on the through-hole 14 side is a spread in the Y-direction perpendicular to the X-direction, which is, for example, the direction in which the waveguide member 40a reaches its tip 45. At least the side surface 51a of the wall portion 50a is conductive, for example, electrically conductive with the conductive surface 11 of the first member 10 and the conductive surface 21 of the second member 20. The length L2 of the side surface 51a of the wall portion 50a is greater than the length of the through-hole 14 in the direction in which the side surface 51a of the wall portion 50a extends in plan view (the Y direction).

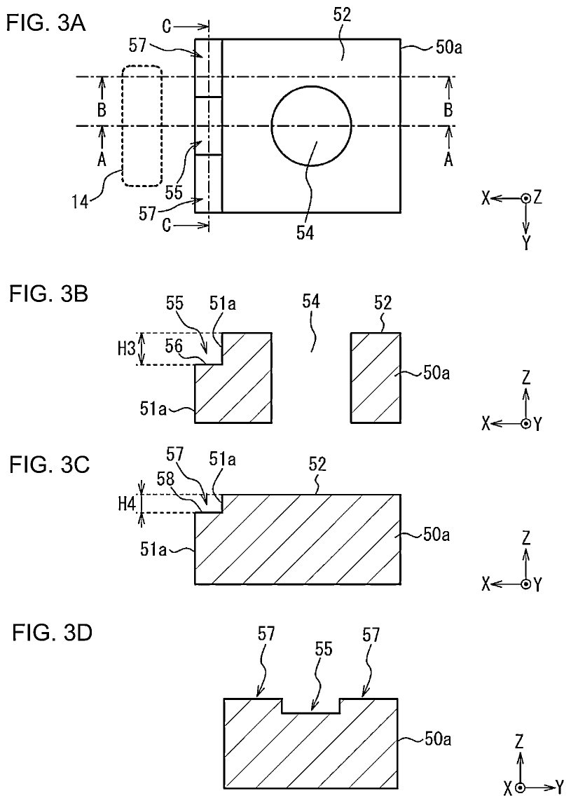

The top edge of the side surface 51a of the wall portion 50a is preferably in contact or inductively coupled with the conductive surface 21 of the second member 20 and electrically conductive with the conductive surface 21. At least a portion of the top end of the wall portion 50a is preferably in contact or inductively coupled with the conductive surface 21 of the second member 20 and electrically conductive. In the wall portion 50a, there is preferably electrical conductivity between the side surface 51a and the bottom surfaces 56, 58 of the step portions 55, 57 (see FIG. 3B and FIG. 3C). The structure may have a conductive material, such as conductive adhesive, conductive oil, conductive rubber, or elastic conductive resin, between the top end of the wall portion 50a and the conductive surface 21. The top end of the wall portion 50a and the conductive surface 21 may have a micro gap or be electrically separated by a thin non-conductive film. In this case, an electromagnetic wave leakage suppression effect can be obtained by the wall portion 50a in a high-frequency coupled state in the electromagnetic wave frequency band being used. In other words, as long as the wall portion 50a has an effect of suppressing leakage of electromagnetic waves, the wall portion 50a and the second member 20 are considered to be in a high-frequency coupled state.

The wall portions 50, 50a have a through-hole 54 that runs between the top end 52, which makes contact or is inductively coupled with the conductive surface 21 of the second member 20, and the bottom end 53, which is opposite the top end 52. At a position corresponding to the through-hole 54, a through-hole 13 passing through the first member 10 is provided in the first member 10 and a through-hole 23 passing through the second member 20 is provided in the second member 20. One of the wall portions 50, 50a may not have a through-hole 54. For example, the wall portion 50 may have about the same width as the rods 30, as in Sample 2 below.

The waveguide device 100 has a fastening member 60. The fastening member 60 is a threaded fastener, such as a bolt. The fastening member 60 is integrally composed of a shaft portion 61 and an umbrella portion 62. The shaft portion 61 passes through the through-hole 23 in the second member 20, the through-hole 54 of the wall portion 50, 50a, and the through-hole 13 in the first member 10, and exits the first member 10 in the −Z direction, to which a fastening member 63 such as a nut is tightened and secured. The umbrella portion 62 is positioned on the +Z side of the second member 20, and receives the tightening pressure transmitted to the shaft portion 61 and transmits this to the second member 20, to secure the second member 20 to the wall portion 50, 50a. Another fastening method is fitting a screw thread that is a male threading provided on the shaft portion 61 into a screw thread that a female threading provided on the inner surface of the through-hole 54 in the wall portion 50, 50a.

FIG. 3A is a plan view of the wall portion 50a in Example 1, FIG. 3B is a cross-sectional view of FIG. 3A from A-A, FIG. 3C is a cross-sectional view of FIG. 3A from B-B, and FIG. 3D is a cross-sectional view of FIG. 3A from C-C. In FIG. 3A, the through-hole 14 adjacent to the wall portion 50a is depicted using dotted lines. As shown in FIG. 3A to FIG. 3D, the wall portion 50a has step portions 55, 57 on the surface on the second member 20 side that are also located on the through-hole 14 side. Step portions 57 are provided to sandwich step portion 55 from the Y direction. The bottom surface 56 of step portion 55 is conductive and separated, by distance H3, from the top end 52, which makes contact with the conductive surface 21 of the wall portion 50a. The bottom surface 58 of step portion 57 is conductive and separated, by distance H4, from the top end 52, which makes contact with the conductive surface 21 of the wall portion 50a. Distance H3 is greater than distance H4 and, for example, about the same as the height H2 of the gap 42. Thus, the bottom surface 56 of step portion 55 and the bottom surface 58 of step portion 57 are not in contact with the conductive surface 21, but are separated from the conductive surface 21. In short, this means distance H3 is between 95% and 105% of height H2. The side surface of step portion 55, which makes contact with the top end 52 of the wall portion 50a and the bottom surface 56 of step portion 55 is part of side surface 51a of the wall portion 50a. Similarly, the side surface of step portion 57, which makes contact with the top end 52 of the wall surface 50a and the bottom surface 58 of step portion 57 is part of side surface 51a of the wall portion 50a.

### Comparative Example

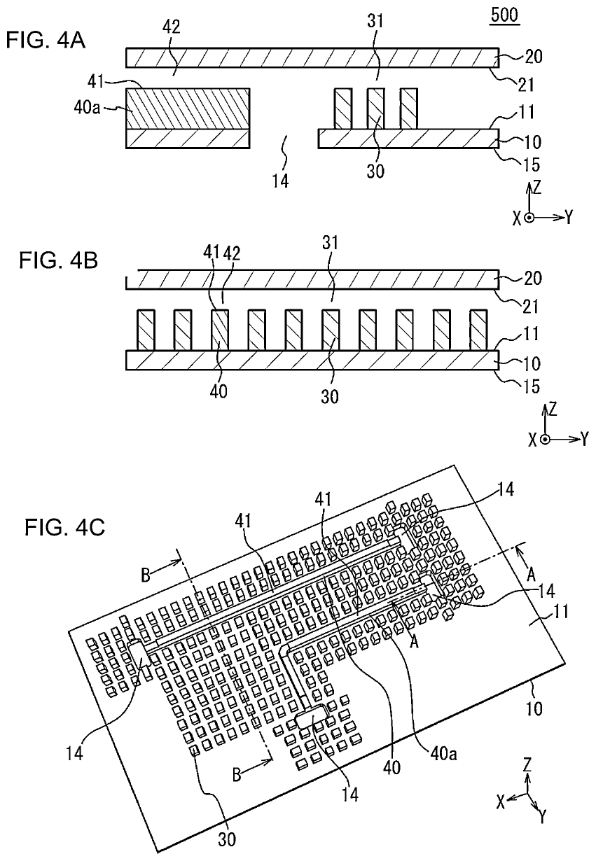

FIG. 4A and FIG. 4B are cross-sectional views of the waveguide device 500 in the comparative example, and FIG. 4C is a perspective view of the second member 20 in the waveguide device 500 in the comparative example. FIG. 4A is a cross-sectional view of the region corresponding to A-A in FIG. 4C, and FIG. 4B is a cross-sectional view of the region corresponding to B-B in FIG. 4C. As shown in FIG. 4A to FIG. 4C, in the waveguide device 500 of the comparative example, the wall portion 50 adjacent to the waveguide member 40 and the wall portion 50a adjacent to the through-hole 14 are not provided. Rods 30 are provided where wall portions 50, 50a are provided in Example 1. The arrangement of the plurality of rods 30 on both sides of the waveguide member 40 and around the through-hole 14 suppresses leakage of electromagnetic waves propagating through the gaps 42 on the waveguide members 40, 40a to the surroundings.

In the comparative example, a plurality of rods 30 are provided adjacent to the waveguide members 40, 40a on both sides of the waveguide members 40, 40a, and a plurality of rods 30 are provided adjacent to the through-hole 14 around the through-hole 14. The rods 30 are located away from the second member 20 to suppress leakage of electromagnetic waves propagating through the gap 42 above the waveguide member 40. Thus, for example, when a peripheral wall is provided outside the waveguide region to the outside of the region in which the plurality of rods 30 are provided, and the first member 10 and the second member 20 are secured by the peripheral wall, as in Patent Document 1, warping of the first member 10 and/or the second member 20 changes the spacing between the waveguide surface 41 of the waveguide members 40, 40a and the conductive surface 21 of the second member 20, and the height of the gap 42 above the waveguide members 40, 40a may differ from the desired size. The formation of unevenness on the waveguide surface 41 is known to change the phase of the propagating electromagnetic waves, and the effect of this unevenness depends on the distance between the waveguide surface 41 and the conductive surface 21. For this reason, the spacing between the waveguide surface 41 and the conductive surface 21 must be precisely set to the desired size, and if the spacing between the waveguide surface 41 and the conductive surface 21 changes and the height of the gap 42 above the waveguide members 40, 40a differs from the desired size, the propagation characteristics of the electromagnetic waves may deteriorate.

In contrast, in Example 1, as shown in FIG. 1B, FIG. 1C, and FIG. 2, wall portion 50 is provided adjacent to the waveguide member 40 without rods 30 interposing, and wall portion 50a is provided adjacent to the through-hole 14 without rods 30 interposing. Thus, the spacing between the first element 10 and the second element 20 in the vicinity of waveguide element 40 and the vicinity of the through-hole 14 is defined by the wall portions 50, 50a. As a result, the height of the gap 42 above the waveguide members 40, 40a can be set to the desired size even if there is warping of the first member 10 and/or the second member 20.

### Simulation 1

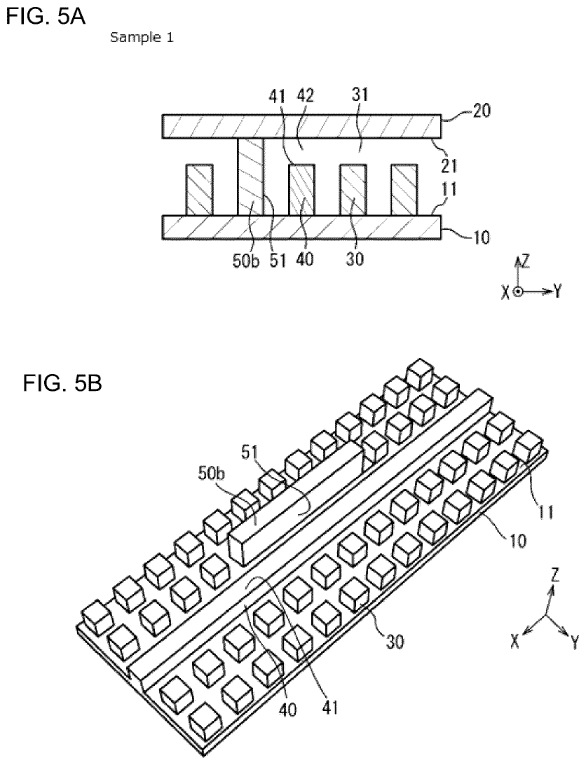

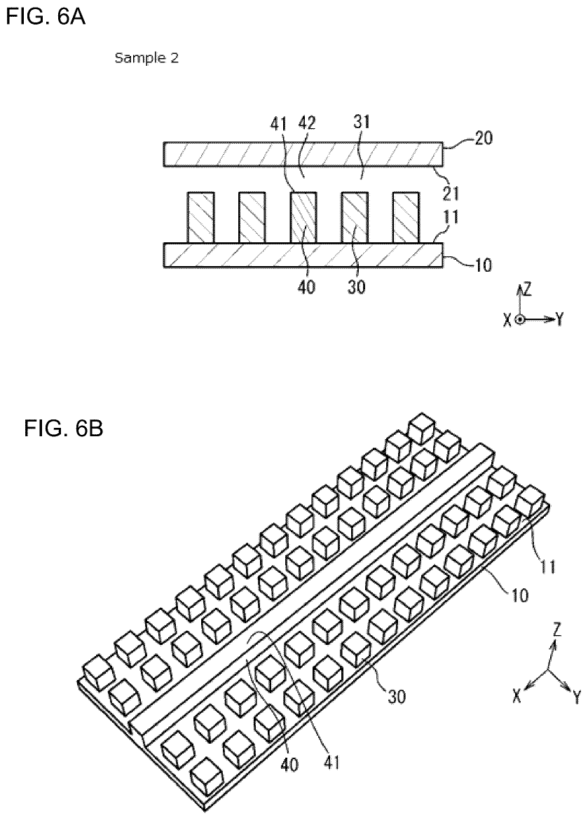

A simulation was performed on the extent of leakage of electromagnetic waves propagating over the waveguide members to the sides when wall portions were installed adjacent to the waveguide members. FIG. 5A is a cross-sectional view of Sample 1 used in Simulation 1, and FIG. 5B is a perspective view of the second member 2 in Sample 1. FIG. 6A is a cross-sectional view of Sample 2 used in Simulation 1, and FIG. 6B is a perspective view of the second member 2 in Sample 2.

As shown in FIG. 5A and FIG. 5B, Sample 1 has a wall portion 50b of the same width as the rods 30 adjacent to a rectilinear waveguide member 40. A plurality of rods 30 are arranged on both sides of the waveguide member 40. No rods 30 are provided in the adjacent region between wall portion 50b and waveguide member 40.

As shown in FIG. 6A and FIG. 6B, in Sample 2, there is no wall adjacent to waveguide member 40, and rods 30 are provided where wall portion 50b is provided in Sample 1.

An electromagnetic simulation was performed to obtain S-parameters for Sample 1 and Sample 2. The simulation conditions were as follows.

### Conditions Shared by Sample 1 and Sample 2

Center frequency of the bandwidth used (operating frequency band): 79 GHz
Width of the rod 30 in the X and Y directions: λ₀/8
Distance between the rods 30: λ₀/8
Z-direction height of the rods 30 and the waveguide member 40: λ₀/4
Distance between the rod 30 and the waveguide member 40: λ₀/8
Distance between the tip of the rods 30 or waveguide member 40 and conductive surface 21: λ₀/8

### Conditions in Sample 1

Wall portion 50b: in contact with the second member 20
Width of the wall portion 50b in the Y direction: λ₀/8
Length of the wall portion 50b in the X direction: λ₀
Distance between the wall portion 50b and the waveguide member 40: λ₀/8

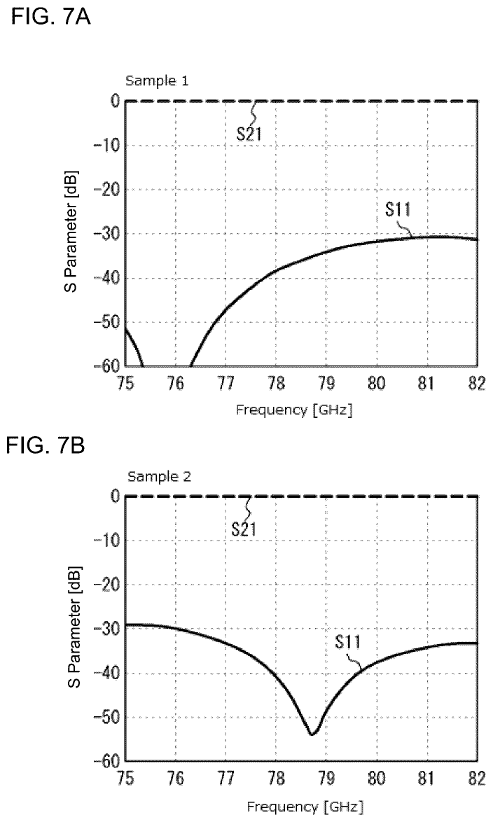

FIG. 7A shows the results of Simulation 1 run on Sample 1 and FIG. 7B shows the results of Simulation 1 run on Sample 2. In FIG. 7A and FIG. 7B, the frequency characteristics of S11 are shown as solid lines, and the frequency characteristics of S21 are shown as broken lines. S11 indicates the return loss, and shows the degree of leakage of electromagnetic waves propagating through the gap 42 above the waveguide member 40. As shown in FIG. 7B, in Sample 2, S11, which indicates the return loss, is slightly greater than −30 dB around 75 GHz, but is somewhat less than −30 dB in the range from 75 GHz to 82 GHz. This indicates the electromagnetic wave propagation blocking effect of the plurality of rods 34. As shown in FIG. 7A, in the case of Sample 1, S11, which indicates the return loss, is −30 dB or less over the entire range from 75 GHz to 82 GHz. This is superior to the characteristics of Sample 2 in FIG. 7B. In other words, when a wall portion 50b is provided adjacent to the waveguide member 40, it is clear from the results of the simulation that an electromagnetic wave propagation blocking effect is obtained that is equivalent to or greater than when a wall portion 50b is not provided and instead only rods 30 are provided.

Therefore, in Example 1, wall portion 50 is provided adjacent to waveguide member 40, while wall portion 50a is provided adjacent to the through-hole 14. However, it can be seen that the same or better electromagnetic wave propagation blocking effect can be realized compared to when a wall portion 50, 50a is not provided and instead only rods 30 are provided.

Also, in Example 1, in addition to the waveguide on the waveguide member 40 formed by arranging a plurality of rods 30 on both sides of the waveguide member 40, a waveguide is also formed on the waveguide member 40 in the section adjacent to the wall portion 50. The waveguide formed in the section adjacent to the wall portion 50 is referred to as waveguide A. Waveguide A is formed by having one side adjacent to the wall portion 50 and the other side adjacent to the rods 30. From the simulation results in FIG. 7A and FIG. 7B, it can be seen that the impedance of waveguide A, which is adjacent to the wall portion 50, is different from the impedance of the other waveguide sandwiched between the rods 30. Therefore, by providing a wall portion 50 and adjusting its length, it is possible to adjust the phase of the signal waves propagating in the waveguide. It has also been found that the wavelength of the propagating electromagnetic waves is extended by about 3% in the section where the side surface 51 of the wall portion 50 is adjacent to the waveguide member 40. From this, it can be seen that waveguide A is a new type of waveguide that has never been seen before. Note that a configuration in which a wall portion 50 is arranged adjacent to both sides of the waveguide member 40 is the same as, for example, a waveguide with a ridge structure having an H-shaped cross-section, and so can be understood to be within the scope of known technology.

### Simulation 2

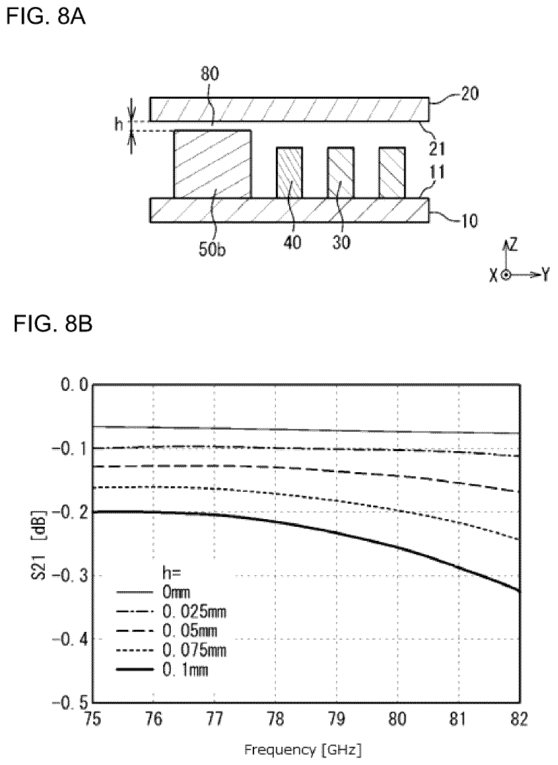

An electromagnetic simulation was conducted to obtain S-parameters when a gap is formed between the wall portion 50b and the second member 20. FIG. 8A is a cross-sectional diagram of the waveguide device used in Simulation 2. As shown in FIG. 8A, the waveguide device used in Simulation 2 has a gap 80 between the wall portion 50b and the second member 20. The width of the wall portion 50b is different from Sample 1. The rest of the configuration is the same as Sample 1. In Simulation 2, the S-parameters were calculated for different spacings h between the wall portion 50b and the second member 20 based on the gap height. The simulation conditions were as follows.
Center frequency of the bandwidth used (operating frequency band): 79 GHz
Width of the rods 30 in the X and Y directions: λ₀/8
Spacing between the rods 30: λ₀/8
Height of the rods 30 and the waveguide member 40 in the Z direction: λ₀/4
Spacing between the rods 30 and the waveguide member 40: λ₀/8
Spacing between the rod 30 tips or waveguide member 40 and conductive surface 21: λ₀/8
Spacings h between the wall portion 50 and the conductive surface 21: 0 mm, 0.025 mm, 0.05 mm, 0.075 mm, 0.1 mm
Width of the wall portion 50 in the Y direction: 3λ₀/8
Length of the wall portion 50 in the X direction: λ₀
Spacing between the wall portion 50 and the waveguide member 40: λ₀/8

FIG. 8B shows the results of Simulation 2. FIG. 8B shows the S21 frequency response. As shown in FIG. 8B, a larger spacing h results in more S21 deterioration. However, when the spacing h is sufficiently small for the wavelength, even if the wall portion 50b is not in contact with the second member 20, it can be seen that S21 can be reduced to a level of degradation that does not interfere with the performance of blocking electromagnetic wave propagation by the wall portion 50b. Even when a gap 80 is formed, if the decrease in S21 due to the gap 80 is within the range acceptable for the intended use, the wall portion 50b and the second member 20 can be said to be in a high-frequency coupled state. The decrease in S21 depends on the opposing area and spacing between the wall portion 50b and the second member 20, and whether the decrease in S21 is acceptable or not depends on the characteristics expected of the waveguide based on the intended use and required performance.

### Simulation 3

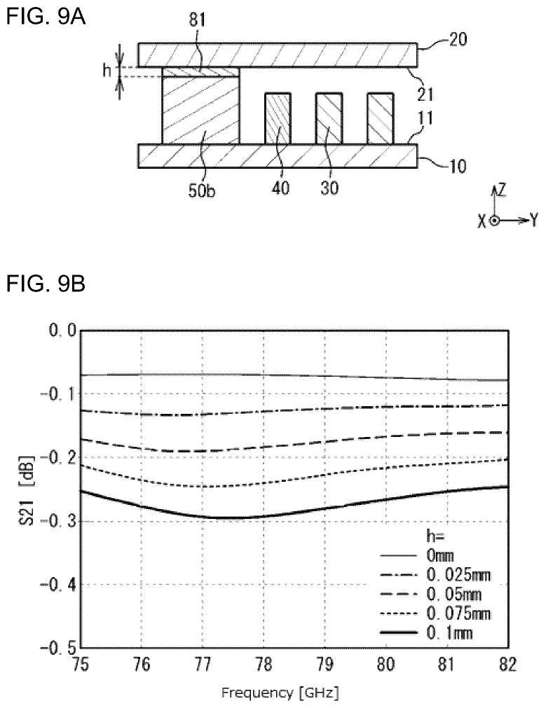

An electromagnetic simulation was performed to determine the S-parameters when a dielectric film is provided between the wall portion 50b and the second member 20. FIG. 9A shows a cross-sectional view of the waveguide device used in Simulation 3. As shown in FIG. 9A, the waveguide device used in Simulation 3 has a dielectric film 81 provided between the wall portion 50b and the second member 20. The width of the wall portion 50b is different from Sample 1. The rest of the configuration is the same as in Sample 1. In Simulation 3, S-parameters were obtained for different spacings h between the wall portion 50b and the second member 20 based on the thickness of the dielectric film 81. The simulation conditions were as follows.
Center frequency of the bandwidth used (operating frequency band): 79 GHz
Width of the rods 30 in X and Y direction: λ₀/8
Spacing of the rods 30: λ₀/8
Height of the rods 30 and the waveguide member 40 in the Z direction: λ₀/4
Spacing between the rods 30 and the waveguide member 40: λ₀/8
Spacing between the rod 30 tips or waveguide member 40 and conductive surface 21: λ₀/8
Spacings h between the wall portion 50 and the conductive surface 21: 0 mm, 0.025 mm, 0.05 mm, 0.075 mm, 0.1 mm
Width of the wall portion 50 in the Y direction: 3λ₀/8
Length of the wall portion 50 in the X direction: λ₀
Spacing between the wall portion 50 and the waveguide member 40: λ₀/8
Dielectric film 81: Engineering plastic with relative permittivity of 3.2 and tan δ of 0.005

FIG. 9B shows the results of Simulation 3. FIG. 9B shows the S21 frequency response. As shown in FIG. 9B, when the dielectric film 81 is provided between the wall portion 50b and the second member 20, although S21 degrades as the spacing h increases, if the spacing h is sufficiently small relative to the wavelength, S21 can be reduced to a level of degradation that does not interfere with the performance of the wall portion 50b in terms of blocking electromagnetic wave propagation. Thus, when a dielectric film 81 is provided, if the decrease in S21 due to the dielectric film 81 is within the range acceptable for the intended use, the wall portion 50b and the second member 20 can be said to be in a high-frequency coupled state. The decrease in S21 depends on the opposing area and spacing between the wall portion 50b and the second member 20, and whether the decrease in S21 is acceptable or not depends on the characteristics expected of the waveguide based on the intended use and required performance.

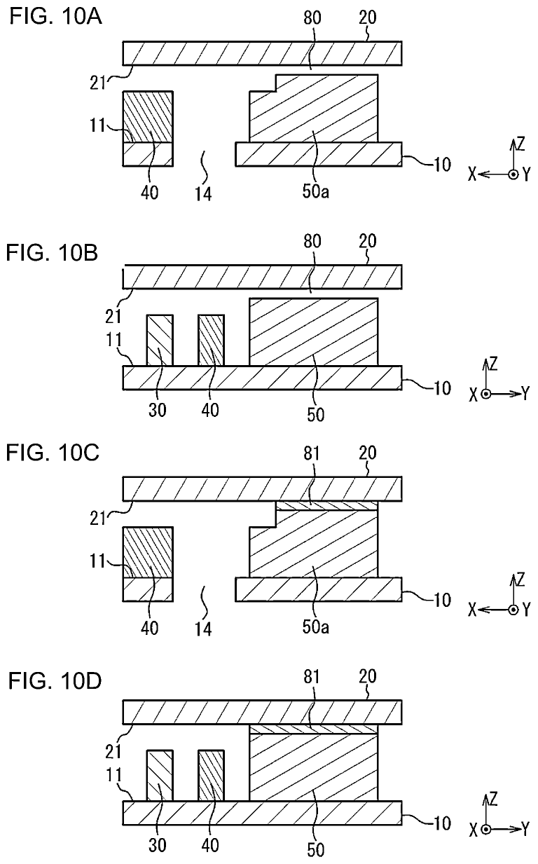

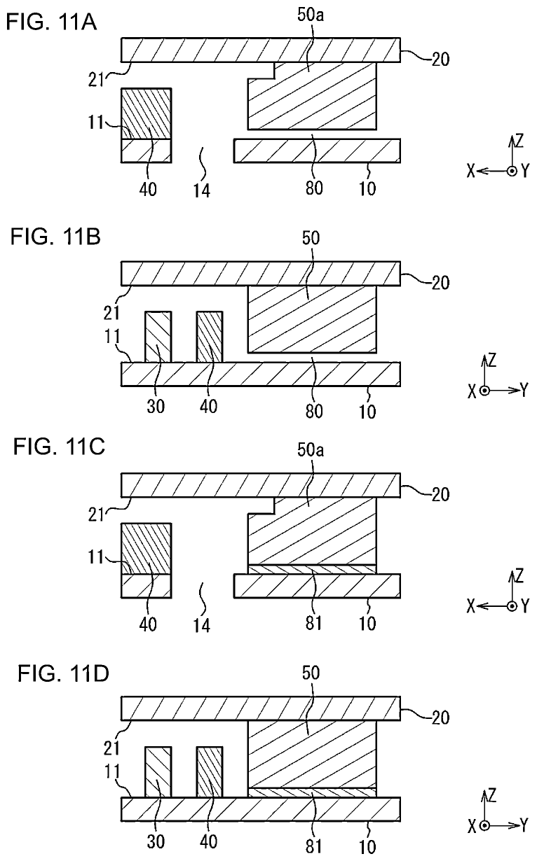

FIG. 10A to FIG. 10D and FIG. 11A to FIG. 11D are cross-sectional views of other examples of wall portions 50, 50a in Example 1. In FIG. 10A to FIG. 10D and FIG. 11A for FIG. 11D, the fastening member and other members have been omitted from the figures for clarity purposes. As shown in FIG. 10A and FIG. 10B, a gap 80 may be formed between the wall portions 50, 50a and the second member 20. As shown in FIG. 10C and FIG. 10D, a dielectric film 81 may be provided between the wall portions 50, 50a and the second member 20. As shown in FIG. 11A and FIG. 11B, a gap 80 may be formed between the wall portions 50, 50a and the first member 10. As shown in FIG. 11C and FIG. 11D, a dielectric film 81 may be provided between the wall portions 50, 50a and the first member 10. If, as in these cases, a gap 80 or dielectric film 81 is provided between the wall portions 50, 50a and the first member 10 or second member 20 and the reduction in S21 due to the gap 80 or dielectric film 81 is within acceptable limits for the intended use, the wall portions 50, 50a and the first member 10 or second member 20 can be said to be in a high-frequency coupled state. A gap 80 or dielectric film 81 may also be provided between the wall portions 50, 50a and both the first member 10 and the second member 20. The height of gap 80 and the thickness of dielectric film 81 may be, for example, λ₀/40 or less, which achieves high-frequency coupling.

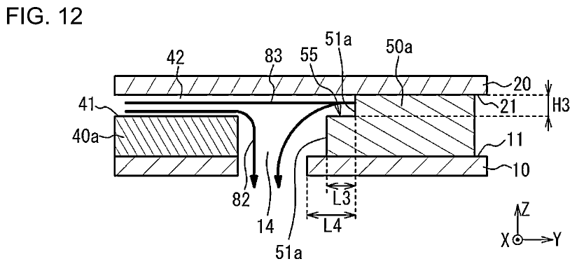

FIG. 12 is a cross-sectional view used to explain the electrical effect of providing a wall portion 50a adjacent to the through-hole 14 in Example 1. In FIG. 12, the fastening member 60 and other members have been omitted from the figure for clarity purposes. As shown in FIG. 12, some of the electromagnetic waves propagating through the gap 42 above the waveguide member 40a propagates directly to the through-hole 14 as indicated by arrow 82, while some is reflected by the side surface 51a of the wall portion 50a adjacent to the through-hole 14 as indicated by arrow 83. Thus, electromagnetic waves that did not propagate directly to the through-hole 14 are reflected by the side surface 51a of the wall portion 50a and propagate to the through-hole 14, thus reducing electromagnetic wave propagation loss. By adjusting the height H3 of step portion 55 in the wall portion 50a, the length L3 of step portion 55, and the length L4 from the through-hole 14 to the side surface 51a at step 55 to the appropriate sizes, the electromagnetic waves that propagate directly to the through-hole 14 and those that are reflected by the wall portion 50a and propagate to the through-hole 14 can be in-phase and the impedance can be matched. For example, height H3 can be about λ₀/4, for example, within the range of λ₀/4±λ₀/8. Length L3 can be, for example, within the range of λ₀/4±λ₀/8. Length L4 can be, for example, within the range of λ₀/2±λ₀/8.

In FIG. 12, electromagnetic waves propagating through the gap 42 above the waveguide member 40a propagate into the through-hole 14, but the same effect can be obtained in the opposite case in which electromagnetic waves propagating through the through-hole 14 propagate into the gap 42 over the waveguide member 40a. In other words, because electromagnetic waves inputted from the through-hole 14 try to spread in all directions after exiting the through-hole 14, some electromagnetic waves propagate into the gap 42, while other waves are reflected by the wall portion 50a before propagating in the gap 42.

As described above, in Example 1, the wall portion 50a is provided adjacent to the through-hole 14 (first through hole) without rods 30 interposing, as shown in FIG. 2. The wall portion 50a is provided between conductive surface 11 of the first member 10 and conductive surface 21 of the second member 20 makes contact or is high-frequency coupled with conductive surface 11 and conductive surface 21. Because the wall portion 50a defines the spacing between the first member 10 and the second member 20 in the vicinity of the through-hole 14 adjacent to the tip 45 of waveguide member 40a, the height of the gap 42 above the waveguide member 40a can be set to the desired size even if the first member 10 and/or the second member 20 is warped. Side surface 51a of the wall portion 50a on the through-hole 14 side is conductive. This reduces the propagation loss of electromagnetic waves, as explained in FIG. 12, as electromagnetic waves are reflected by the side surface 51a of the wall portion 50a and propagate through the gap 42 above the waveguide member 40a or the through-hole 14.

In Example 1, as shown in FIG. 1(b), side surface 51a of wall portion 50a on the through-hole 14 side is located opposite the tip 45 of waveguide member 40a across through-hole 14. This makes it easier for some of the electromagnetic waves propagating through one of the gap 42 above the waveguide member 40a and the through-hole 14 to be reflected by side surface 51a of the wall portion 50a before propagating to the other of gap 42 and the through-hole 14.

In Example 1, as shown in FIG. 2, side surface 51a of wall portion 50a on the through-hole 14 side is perpendicular to the direction in which the waveguide member 40a extends toward the tip 45. This makes it easier for some of the electromagnetic waves propagating through one of the gap 42 above the waveguide member 40a and the through-hole 14 to be reflected by side surface 51a of the wall portion 50a before propagating to the other of gap 42 and the through-hole 14. The meaning of perpendicular here is not limited to the side surface 51a being perfectly perpendicular to the direction in which the waveguide member 40a extends, but to the side surface 51a being inclined within ±10° relative to the direction in which the waveguide member 40a extends.

In Example 1, as shown in FIG. 3A to FIG. 3D, the wall portion 50a has a step portion 55 separated from the second member 20 at a point located on the through-hole 14 side of the surface on the second member 20 side. This makes it easier for some of the electromagnetic waves propagating through the gap 42 above the waveguide member 40a or the through-hole 14 to be reflected by the side surface 51a of the wall portion 50a. In terms of impedance matching between the electromagnetic waves directly propagated in the gap 42 or through-hole 14 and those reflected on the side surface 51a of the wall portion 50a, steps 55 and 57 are preferably provided at two different heights. For steps 55 and 57, the optimum step shape is determined by checking the simulation results in the design stage. Therefore, the number, shape, height, and/or depthwise length of steps 55 and 57 are determined in the design stage. Example 1 shows step portions for a situation in which the electromagnetic wave frequency band being used is 76 GHz to 81 GHz.

In Example 1, as shown in FIG. 2, the length L2 of the side surface 51a of the wall portion 50a on the through-hole 14 side is greater than the length of the through-hole 14 in the Y direction in which the side surface 51a of the wall portion 50a extends in plan view. This makes it easier for some of the electromagnetic waves propagating through the gap 42 above the waveguide member 40a or the through-hole 14 to be reflected by the side surface 51a of the wall portion 50a.

Also, in Example 1, the length L2 of the side surface 51a of the wall portion 50a on the through-hole 14 side is greater than the spacing between conductive surface 11 and conductive surface 21 at the location of the wall portion 50a. This keeps the difference between the length L2 of the wall portion 50a and the width W2 of the rods 30 in the direction along the side surface 51a from becoming smaller. Therefore, because disruption in the effect of suppressing leakage of electromagnetic waves propagating through gap void 42 above the waveguide member 40a is suppressed, a good electromagnetic wave propagation blocking effect can be obtained for the electromagnetic waves propagating through the gap 42. The length L2 is preferably at least 1.5 times the spacing between conductive surface 11 and conductive surface 21, more preferably at least 2.0 times the spacing, and even more preferably at least 2.5 times the spacing. However, if the length L2 is too long, the effect of suppressing leakage of electromagnetic waves propagating through the gap 42 on the waveguide member 40a will be disrupted. Therefore, length L2 is preferably no more than five times the spacing between conductive surface 11 and conductive surface 21, more preferably no more than four times the spacing, and even more preferably no more than three times the spacing.

In Example 1, as shown in FIG. 1B, the second member 20 is fastened to the wall portion 50a adjacent to the through-hole 14 by a fastening member 60. Specifically, the second member 20 is pressed against the wall portion 50a by the fastening member 60, and the top end 52 of the wall portion 50a and the conductive surface 21 of the second member 20 are brought into close contact. This ensures that the spacing between the first member 10 and the second member 20 is a good size.

A typical WRG waveguide device is composed of multiple layers. These layers are assembled using bolts or some other fastening method in a configuration that maintains a constant spacing. In conventional WRG waveguide devices, this spacing is secured by using spacers or other components placed between each layer, or by integrating the spacers into each layer. These spacers were provided outside of the waveguide region, as shown in Patent Document 1. In contrast, in Example 1, the wall portion 50a serves as a spacer. In Patent Document 1, because the spacer is located to the outside of the waveguide region, a region needs to be provided for a spacer on the outer periphery of the waveguide device. This makes the waveguide device larger. In contrast, in Example 1, the wall portion 50a provided in the waveguide region adjacent to the through-hole 14 functions as a spacer, allowing the size of the waveguide device 100 to be reduced.

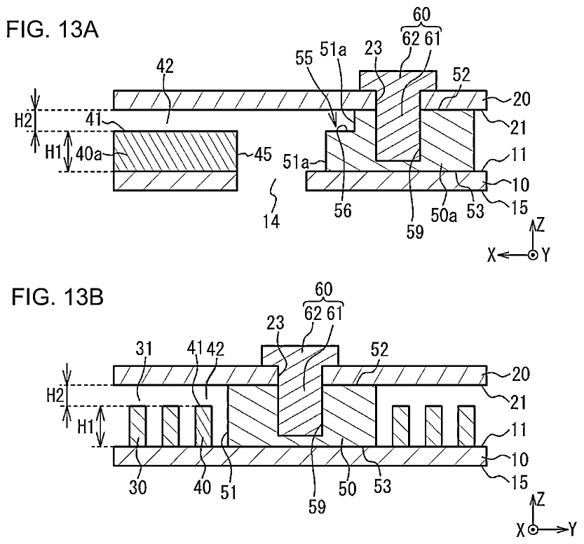

In Example 1, as shown in FIG. 1B, the wall portion 50a has a through hole 54 (second through hole) in the top end 52 that makes contact with the conductive surface 21 of the second member 20. The second member 20 is fastened to the wall portion 50a by the fastening member 60 inserted into the through-hole 54. This allows the second member 20 to be firmly secured to the wall portion 50a. Instead of the through-hole 54, a recessed portion 59 with a bottom surface may be provided in the top ends 52 of the wall portions 50, 50a, as shown in FIG. 13A and FIG. 13B, and a fastening member 60 may be inserted into these recessed portions 59. The through-holes 54 and recessed portion 59 are not limited being provided in a top end 52 that makes contact with the conductive surface 21, and may also be provided in the top surface that does not make contact with the conductive surface 21.

Thus, the wall portions 50, 50a play two roles, namely, determining the spacing between the first member 10 and the second member 20, and securing the second member 20 to the wall portions 50, 50a. The location of wall portion 50 should be adjacent to waveguide member 40 or waveguide member 40a and with sufficient space to allow for placement of a wide wall portion 50. Similarly, the location of wall portion 50a should be adjacent to the through-hole 14 and with sufficient space to allow for placement of a wide wall portion 50a. For example, if the electromagnetic wave frequencies to be used are in the 76 GHz to 81 GHz band, the free-space wavelength λ₀ is almost 4 mm. In a WRG waveguide, the placement period T of the rods 30 is typically selected to be about λ₀/4. In one example, if the size of the waveguide device is taken into consideration and a diameter of 2 mm is wanted for the fastening member 60, the top end of the wall portions 50, 50a with the through-hole 54 may be a 4×4 mm square or larger. In this case, the length of the side surface 51 of the wall portion 50 facing the waveguide member 40 is 4 mm or more, which is almost equal to or greater than the free-space wavelength λ₀. This determines the length of the wall portions 50, 50a with a through-hole 54 into which a fastening member 60 is inserted.

Unlike microstrip lines used in conventional patch antennas (microstrip lines being limited in practical use to a two-dimensional arrangement because of the high loss when waveguides are connected between layers), a three-dimensional waveguide arrangement is possible in WRG waveguides. Therefore, the designer can freely select the positions at which the multiple waveguide layers that constitute the waveguide device and the spacing between the first and second members determined by the wall portions. This design freedom can be utilized to place the wall portions in the most effective locations. Thus, by taking advantage of the design freedom associated with WRG waveguides, the placement of the wall portions can be optimized. This makes it possible to assemble a waveguide device as designed and realize a high-performance waveguide device.

In Example 1, the conductive surface 21 of the second member 20 comes into contact only with the top ends of the two wall portions 50, 50a. In Patent Document 1, the portion corresponding to the spacer is realized by a peripheral wall that is located outside the waveguide region to the outside of the rods and is an outer portion of the member corresponding to the first member 10. In other words, the top end of this peripheral wall and the bottom surface of the member corresponding to the second member 20 are in contact with each other, thereby maintaining a gap that is the height of this peripheral wall. In a comparison of the structure of Patent Document 1 with that of Example 1, the waveguide device is larger in Patent Document 1 by the region for the peripheral wall. In the structure of Patent Document 1, the member corresponding to the first member 10 and the member corresponding to the second member 20 are secured only in the peripheral wall portion of the outer circumference, so if there is warping in the central portion of these members, the gap between the two members in the central portion will change. In contrast, in Example 1, wall portions 50, 50a are provided within the waveguide region, that is, to the inside of the rods 30. In the design process, wall portions 50, 50a can be provided within any waveguide region. This makes it possible to realize a more uniform and precise dimension for the height of the gap 42 between the waveguide surface 41 of the waveguide members 40, 40a and the conductive surface 21 of the second member 20, even if the central portion is warped.

In Example 1, as shown in FIG. 2, the bent portion 43 of the waveguide member 40a is bent in a quarter circle arcuate shape, but it may be bent into any other curved shape, such as an elliptical arcuate shape or free curve shape, or may be bent at right angles. It may be bent at right angles, or the outer corners may be chamfered.

### Modified Examples 1-3

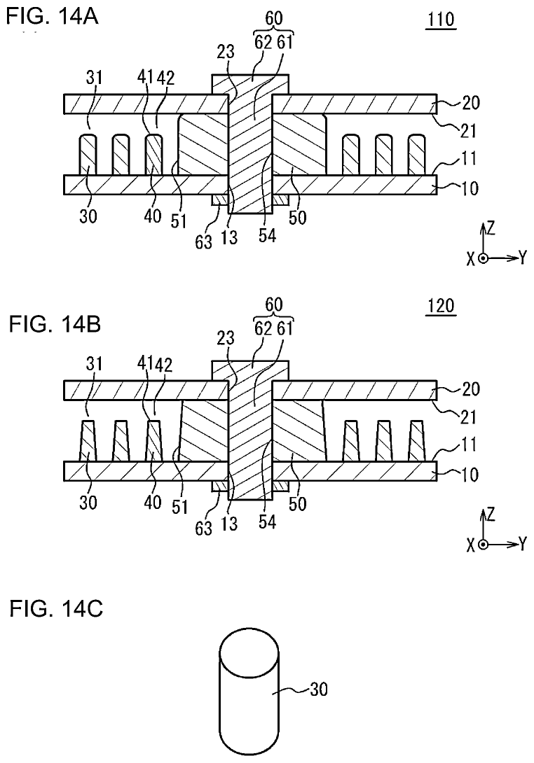

FIG. 14A and FIG. 14B are cross-sectional views of the waveguide devices 110, 120 in Modified Examples 1 and 2 of Example 1, and FIG. 14C is a perspective view of the rods 30 in Modified Example 3 of Example 1. As shown in FIG. 14A, in the waveguide device 110 of the Modified Example 1 of Example 1, the edges of the rods 30, the waveguide member 40, and the wall portion 50 are rounded (corner rounding). The rounded shape may be chamfered. Although omitted from FIG. 14A, the edges of the waveguide member 40a and wall portion 50a are also rounded (corner rounding). Electromagnetic simulations have shown that making the edges of the rods 30 and waveguide devices 40, 40a rounded or chamfered has the effect of increasing the frequency characteristics of electromagnetic wave propagation, particularly in the bandwidth being used. The dimensions of these rounded and chamfered portions, as well as the locations where they are used, are determined based on the results of electromagnetic simulations performed during the design stage. Therefore, any conceivable variation is possible.

As shown in FIG. 4B, in the waveguide device 120 of Modified Example 2 of Example 1, the rods 30, the waveguide member 40, and the wall portion 50 have a shape that gradually tapers from the conductive surface 11 toward the conductive surface 21. In other words, the sides of these members are tapered. Although omitted from FIG. 14B, the waveguide member 40a and wall portion 50a also have a shape that gradually tapers from the conductive surface 11 to the conductive surface 21. The gradual tapering of the rods 30, waveguide members 40, 40a, and wall portions 50, 50a makes it easier to mold the rods 30, waveguide members 40, 40a, and wall portions 50, 50a together with the first member 10 using resin or metal. In addition, electromagnetic simulations have shown that the gradual tapering of the rods 30, waveguide devices 40, 40a, and wall portions 50, 50a has the effect of improving the frequency characteristics of electromagnetic wave propagation. This narrowing shape does not refer only to a shape that continuously narrows, but also a shape that narrows once and then maintains the same thickness, or even a shape that narrows once again. Any shape can be used, as long as it does not get gradually thicker.

As shown in FIG. 14C, the rods 30 in Modified Example 3 of Example 1 have a cylindrical shape. In other words, the rods 30 have a circular shape when viewed in plan view. Electromagnetic simulations have shown that using a cylindrical shape for the rods 30 has the effect of improving the frequency characteristics of electromagnetic wave propagation, particularly in the bandwidth being used. The rods 30 may also have an elliptic pillar shape, that is, being an ellipse in plan view, or may be an oval shape in plan view.

The rounded (corner rounded) edges and chamfered edges described in Modified Example 1 of Example 1, the tapers described in Modified Example 2 of Example 1, and the cylindrical pillar portions described in Modified Example 3 of Example 1, can also be applied to Example 2.

### Modified Examples 4, 5

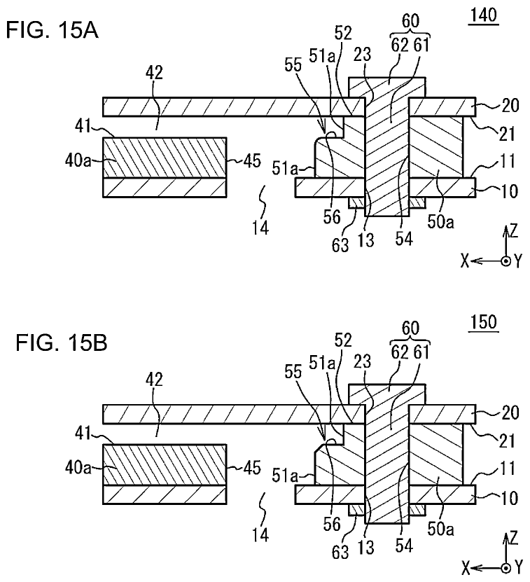

FIG. 15A and FIG. 15B are cross-sectional views showing the vicinity of the wall portion 50a in Modified Examples 4 and 5 of Example 1. As shown in FIG. 15A, in the waveguide device 140 of the Modified Example 4 of Example 1, the edges of step portion 55 of the wall portion 50 are rounded (corner rounding). Although omitted from FIG. 15A, the edges of step portion 57 of wall portion 50a are also rounded (corner rounding). The dimensions of rounding and the location of the rounding adopted are determined based on the results of electromagnetic simulations in the design stage.

As shown in FIG. 15B, in the waveguide device 150 in Modified Example 5 of Example 1, the edge of step portion 55 of the wall portion 50a is chamfered. While omitted from FIG. 14B, the edge of step portion 57 of the wall portion 50a is also chamfered. The dimensions of the chamfering and which portion is chamfered are determined based on the results of an electromagnetic simulation during the design stage.

The rounding of the edge described in Modified Example 4 of Example 1 and the chamfering of the edge described in Modified Example 5 of Example 1 are also applicable to Example 2.

### Modified Examples 6, 7

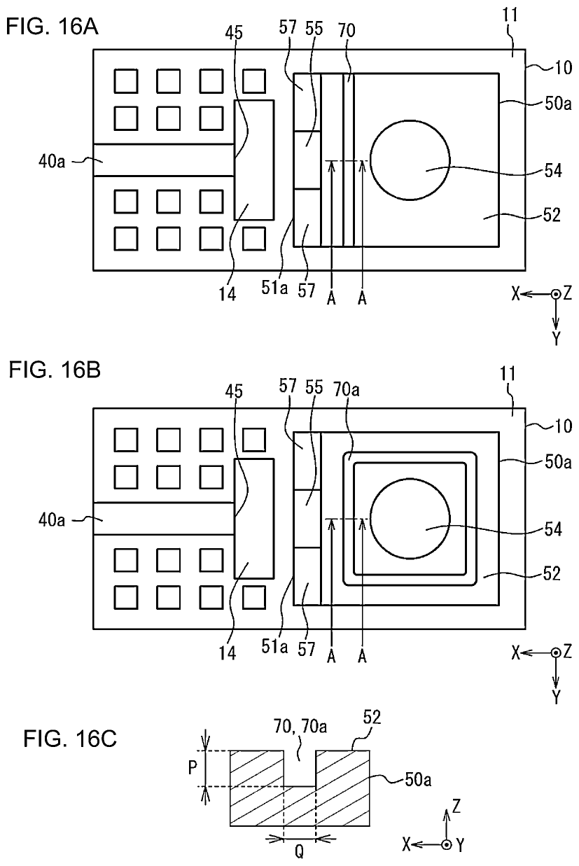

FIG. 16A and FIG. 16B are plan views showing the vicinity of the wall portion 50a in Modified Examples 6 and 7 of Example 1, and FIG. 16C is a cross-sectional view of the wall portion in FIG. 16A and FIG. 16B from A-A. As shown in FIG. 16A and FIG. 16C, in Modified Example 6 of Example 1, a groove 70 is provided at the top end 52 of the wall portion 50a between through-hole 54 and through-hole 14. The groove 70 extends in the Y direction. The groove 70 may opens, for example, into both opposing side walls of the wall portion 50a, but does not have to reach both side walls. The depth P of the groove 70 can be, for example, λ₀/4.

The groove 70 forms a waveguide in the depth direction. Electromagnetic waves that enter the groove 70 propagate in the depth direction of the groove 70 and are reflected at the bottom. When the reflected electromagnetic waves return to the entrance of the groove 70, it has changed by 180° compared to the phase at the time of entry. This causes the electromagnetic waves reflected at the bottom of the groove 70 to cancel out the electromagnetic waves entering the groove 70, causing the electromagnetic waves to attenuate. This is the effect of the electromagnetic wave propagation blocking action of the groove 70.

There are no particular restrictions on the width Q of the groove 70, which may, for example, be λ₀/4 or less or about λ₀/8. The groove 70 is formed at the top end 52 of the wall portion 50a, to the outside of the through-hole 54 and to the inside of the side wall on the through-hole 14 side. The sides of groove 70 may have a taper that gradually widens from the bottom. This tapered shape may not only continuously widen as it gets further from the bottom, but in some parts may remain constant without widening. In other words, the tapered shape can be any shape, as long as it does not become narrower as it gets further from the bottom.

As shown in FIG. 16B and FIG. 16C, a groove 70a is provided that surrounds the through-hole 54 in Modified Example 7 of Example 1. In other words, the groove 70a is located to the outside of through-hole 54 and to the inside of the side wall of wall portion 50a, and is provided on the top end 52 of wall portion 50a so as to surround through-hole 54. In plan view, the shape of the groove 70a may be rectangular with rounded corners or circular. In addition, the groove 70a may be tapered, as in the case of groove 70.

The depth P of grooves 70 and 70a is preferably λ₀/4, but a depth within the range of λ₀/4±λ₀/8 is allowed. Simulation and measurement results have shown that there is an electromagnetic wave propagation blocking effect when the depth P of grooves 70 and 70a is within the range of λ₀/4±λ₀/8. Specifically, a depth P that realizes the optimal shielding effect in relation to the surrounding components can be selected in the design stage.

Thus, in Modified Examples 6 and 7 of Example 1, as shown in FIG. 16A and FIG. 16B, the wall portion 50a has grooves 70, 70a located between the through-hole 54 (second through hole) at the top end 52 and the through-hole 14 (first through hole) running in the direction intersecting the direction in which the tip 45 of the waveguide member 40a and the side surface 51a of the wall portion 50a portion face each other. The depth P of the groove 70, 70a is within the range of λ₀/4±λ₀/8. This causes the electromagnetic waves that enter the groove 70, 70a to cancel each other out and attenuate as they are reflected at the bottom of the grooves 70, 70a. In this way, electromagnetic waves can be suppressed from leaking out from the through-hole 54. Running in the direction intersecting the direction in which the tip 45 of the waveguide member 40a and the side surface 51a of the wall portion 50a portion face each other includes not only perpendicular to the direction in which they face each other, but inclined 30° or less with respect to the direction in which they face each other.

In addition, in Modified Example 7 of Example 1, as shown in FIG. 16B, a groove 70a is provided that surrounds the through-hole 54. This makes it possible to further suppress electromagnetic wave leakage.

The grooves 70, 70a shown in Modified Examples 6 and 7 of Example 1 can also be applied to Example 2. By applying such a groove 70, 70a, electromagnetic wave leakage can be reduced further and a high-performance waveguide device can be realized.

### Example 2

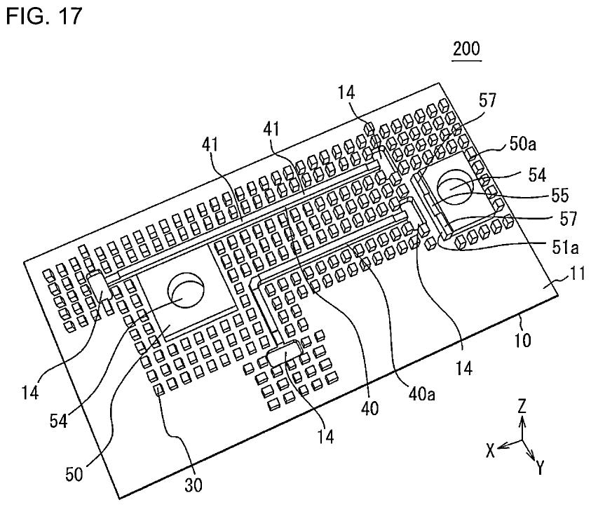

FIG. 17 is a perspective view of the second member 20 and the fastening member 60 in the waveguide device 200 in Example 2. As shown in FIG. 17, in the waveguide device 200 in Example 2, rods 30 are provided in the peripheral region adjacent to the sidewalls of the wall portion 50a, excluding the region between the wall portion and the through-hole 14. The rest of the configuration is the same as in Example 1, so further explanation has been omitted.

In Example 2, the rods 30 surround the wall portion 50a except between the wall portion 50a and the through-hole 14. This can suppress the leakage of electromagnetic waves via the wall portion 50a. For example, in a structure in which a fastening member 60 is inserted into the wall portion 50a, electromagnetic waves can easily leak outside via the wall portion 50a. In such a case, it is useful to provide rods 30 adjacent to the sidewalls of the wall portion 50a to surround the wall portion 50a.

In Examples 1 and 2, through-hole 14 is an ellipse in plan view, but it may be any shape that constitutes a waveguide, such as rectangular, square, oval, U-shaped, or H-shaped shape. Also, in Examples 1 and 2, the wall portion 50a is placed near the side along the long axis of the through-hole 14, which is an oval shape having a short axis and a long axis. However, the wall portion 50a may also be located near the side along the short axis of the through-hole 14. Where to place the wall portion 50a with respect to the through-hole 14 can be determined freely based on the results of an electromagnetic simulation during the design stage of the waveguide device.

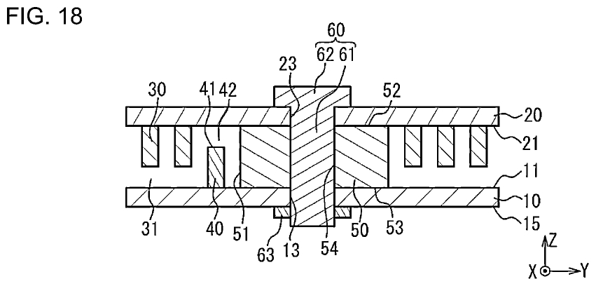

In Examples 1 and 2, the waveguide members 40 and 40a may be a portion of the second member 20 and may protrude from conductive surface 21 toward conductive surface 11. In this case, the tip surfaces of the waveguide members 40 and 40a are still waveguiding surfaces 41, and electromagnetic waves propagate through the gap 42 between the waveguide surfaces 41 and conductive surface 11. Also, the plurality of rods 30 may be a portion of the first member 10 and protrude from conductive surface 11 toward conductive surface 21 and have a gap 31 between them and conductive surface 21, as shown in FIG. 1C, or may be a portion of the second member 20 and protrude from conductive surface 21 toward conductive surface 11 and has a gap 31 between them and conductive surface 11, as shown in FIG. 18. From the standpoint of making the distance between the waveguide members 40 and 40a and the rods 30 the appropriate size, when the waveguide members 40 and 40a are a portion of the first member 1 and protrude from conductive surface 11 toward conductive surface 21, the rods 30 are preferably a portion of the first member 10 and project from conductive surface 11 toward conductive surface 21. When the waveguide members 40 and 40a are a portion of the second member 1 and protrude from conductive surface 21 toward conductive surface 21, the rods 30 are preferably a portion of the second member 20 and project from conductive surface 21 toward conductive surface 11.

While embodiments of the invention have been described in detail above, the present invention is not limited to such specific embodiments, and modifications and changes are possible within the scope and spirit of the invention described in the claims.

What is claimed is:

1. A waveguide device comprising:
a first member that has a conductive first surface and a first through-hole passing between the first surface and a second surface on the side opposite the first surface and having a conductive inner surface in contact with the first surface;
a second member that has a conductive third surface facing the first surface;
a waveguide member that is provided to extend in the planar direction of the first surface between the first surface and the third surface, is in contact with first surface, forms a first gap with the third surface, and has a tip adjacent to the first through-hole and a conductive waveguide surface facing the third surface;
a plurality of rods each having a conductive surface that are provided around the waveguide member between the first surface and the third surface, are in contact with one of the first surface and the third surface and form a second gap with the other surface, and are not arranged between the first through-hole and the tip of the waveguide member;
and a wall portion that is in contact with or is high-frequency coupled to the first surface and the third surface and provided adjacent to the first through-hole between the first surface and the third surface without the rods interposed therebetween, and has at least a conductive side surface on the first through-hole side.

2. The waveguide device according to claim 1, wherein the side surface of the wall portion is located opposite the tip of the waveguide member with the first through-hole interposed therebetween.

3. The waveguide device according to claim 2, wherein the side surface of the wall portion is perpendicular to the direction in which the waveguide member extends to the tip.

4. The waveguide device according to claim 2, wherein the wall portion has a step portion away from the second member at a point on the surface of the second member side that is located on the first through-hole side.

5. The waveguide device according to claim 2, wherein the length of the side surface of the wall portion in the planar direction is greater than the length of the first through-hole in the direction in which the side surface of the wall portion extends in plan view.

6. The waveguide device according to claim 1, wherein some of the plurality of rods surrounds the wall portion except between the wall portion and the first through-hole.

7. The waveguide device according to claim 1, wherein the length of the side surface of the wall portion in the planar direction is greater than the distance between the first surface and the third surface at the location of the wall portion.

8. The waveguide device according to claim 1, wherein the plurality of rods extend toward the third surface in contact with the first surface and form a second gap between them and the third surface.

9. The waveguide device according to claim 1, further comprising a fastening member that fastens the second member to the wall portion.

10. The waveguide device according to claim 9, wherein the top surface of the wall portion has a second through-hole or recessed portion, and
the second member is fastened to the wall portion by inserting the fastening member into the second through-hole or recessed portion.

11. The waveguide device according to claim 10, wherein the wall portion has a groove in a direction intercepting the direction in which the tip of the waveguide member and the side surface of the wall portion face each other, located between the second through-hole or recessed portion and the first through-hole on the top surface, and
the depth of the groove is within the range of λ₀/4±λ₀/8 where λ₀ is the free-space wavelength at the center frequency of the frequency band being used.

12. The waveguide device according to claim 11, wherein the groove is provided around the second through-hole or recessed portion.

13. The waveguide device according to claim 1, wherein the wall portion defines the distance between the first member and the second member.

14. The waveguide device according to claim 1, further comprising a dielectric film between at least one of the first surface and the second surface and the wall portion.
